(19) United States
(12) Patent Application Publication
(10) Pub. No.: US 2013/0155205 A1
(43) Pub. Date: Jun. 20, 2013

(54) IMAGE PROCESSING DEVICE, IMAGING DEVICE, AND IMAGE PROCESSING METHOD AND PROGRAM

(71) Applicants: Ryota Kosakai, Tokyo (JP); Seijiro Inaba, Kanagawa (JP)

(72) Inventors: Ryota Kosakai, Tokyo (JP); Seijiro Inaba, Kanagawa (JP)

(73) Assignee: SONY CORPORATION, Tokyo (JP)

(21) Appl. No.: 13/819,238

(22) PCT Filed: Sep. 12, 2011
(86) PCT No.: PCT/JP2011/070706

§ 371 Date: Feb. 26, 2013

(30) Foreign Application Priority Data
Sep. 22, 2010 (JP) 2010-212193

(51) Int. Cl. G06T 15/20; H04N 13/02

(52) U.S. Cl. CPC G06T 15/205; H04N 13/021
USPC 348/50; 382/154

(57) ABSTRACT

In the configuration in which a two-dimensional panoramic image or images used for displaying a three-dimensional image are generated by connecting stripped areas cut out from a plurality of images, a composition image that can be generated is determined based on the movement of the camera, and the determined composition image is generated. In the configuration in which a two-dimensional panoramic image or left-eye and right-eye images used for a three-dimensional image are generated by connecting stripped areas cut out from a plurality of images, it is determined whether or not a two-dimensional panoramic image or a three-dimensional image can be generated by analyzing the movement of an imaging apparatus at the time of capturing images, and a composition image that can be generated is generated.

### DESCRIPTION

1. Technical Field

The present invention relates to an image processing apparatus, an imaging apparatus, an image processing method, and a program, and, more particularly, to an image processing apparatus, an imaging apparatus, an image processing method, and a program that perform the process of generating an image used for displaying a three-dimensional image (3D image) using a plurality of images captured while moving a camera.

2. Background Art

In order to generate a three-dimensional image (also called a 3D image or a stereoscopic image), it is necessary to capture images from mutually different viewpoints, in other words, a left-eye image and a right-eye image. Methods of capturing images from mutually different viewpoints are largely divided into two methods.

A first technique is a technique of simultaneously imaging a subject from different viewpoints using a plurality of camera units, that is, a technique using a so-called multi-lens camera.

A second technique is a technique of consecutively capturing images from mutually different viewpoints by moving an imaging apparatus using a single camera unit, that is, a technique using a so-called single-lens camera.

For example, a multi-lens camera system that is used for the above-described first technique has a configuration in which lenses are included at positions separated from each other and a subject can be simultaneously photographed from mutually different viewpoints. However, a plurality of camera units are necessary for such a multi-lens camera system, and accordingly, there is a problem in that the camera system is high priced.

In contrast to this, a single-lens camera system that is used for the above-described second technique may have a configuration including one camera unit, which is similar to the configuration of a camera in related art. In such a configuration, images from mutually different viewpoints are consecutively captured while moving a camera that includes one camera unit, and a three-dimensional image is generated by using a plurality of captured images.

As above, in a case where a single-lens camera system is used, a relatively low-cost system can be realized by using one camera unit, which is similar to a camera in related art.

In addition, as a technique in related art that discloses a technique of acquiring distance information of a subject from images captured while a single-lens camera is moved, there is NPL 1 “Acquiring Omni-directional Range Information (The Transactions of the Institute of Electronics, Information and Communication Engineers, D-II, Vol. J74-D-II, No. 4, 1991)”. In addition, also in NPL 2 “Omni -Directional Stereo”, IEEE Transaction On Pattern Analysis And Machine Intelligence, VOL. 14, No. 2, February 1992”, a report of the same content as that of NPL 1 is disclosed.

In NPL 1 and NPL 2, a technique is disclosed in which a camera is fixedly installed on a circumference that is separated from the rotation center of a rotation target by a predetermined distance, and distance information of a subject is acquired by using two images acquired through two vertical slits by consecutively capturing images while rotating a rotation base.

In addition, in PTL 1 (Japanese Unexamined Patent Application Publication No. 11-164326), similarly to the configurations disclosed in NPL 1 and NPL 2, a configuration is disclosed in which images are captured while a camera is installed to be separated from the rotation center of a rotation target by a predetermined distance and is rotated, and by using two images acquired through two slits, a left-eye panoramic image and a right-eye panoramic image that are used for displaying a three-dimensional image are acquired.

As above, in the techniques in related art, it is disclosed that, by using images acquired through slits while a camera is rotated, a left-eye image and a right-eye image that are used for displaying a three-dimensional image can be acquired.

Meanwhile, a technique for generating a panoramic image, that is, a horizontally-long two-dimensional image by capturing images while a camera is moved and connecting a plurality of captured images is known. For example, in PTL 2 (Japanese Patent No. 3928222), PTL 3 (Japanese Patent No. 4293053), and the like, techniques for generating a panoramic image are disclosed.

As above, when a two-dimensional panoramic image is generated, a plurality of captured images acquired while a camera is moved is used.

In NPL 1, NPL 2, and PTL 1 described above, a principle of acquiring a left-eye image and a right-eye image as three-dimensional images by cutting out and connecting images of predetermined areas using a plurality of images captured by a capturing process such as a panoramic image generating process is described.

However, in a case where a left-eye image and a right-eye image as a three-dimensional image or a two-dimensional panoramic image is generated by cutting out images of predetermined areas from a plurality of captured images captured with a camera moving and connecting the images, for example, through a user's swinging operation of the camera on his hands, there is a case where the left-eye image and the right-eye image for displaying a three-dimensional image cannot be generated depending on the form of the movement of the camera that is performed by a user. In addition, there is a case where a two-dimensional panoramic image cannot be generated. As a result, meaningless image data is recorded on a medium as recording data, and a situation may occur in which an image not according to user's intention is reproduced at the time of reproduction, or an image cannot be reproduced.

### CITATION LIST

### Patent Literature

[PTL 1] JP-A-11-164326

[PTL 2] Japanese Patent No. 3928222

[PTL 3] Japanese Patent No. 4293053

### Non Patent Literature

[NPL 1] “Acquiring Omni-directional Range Information (The Transactions of the Institute of Electronics, Information and Communication Engineers, D-II, Vol. J74-D-II, No. 4, 1991)”

[NPL 2] “Omni -Directional Stereo”, IEEE Transaction On Pattern Analysis And Machine Intelligence, VOL. 14, No. 2, February 1992”

### SUMMARY OF INVENTION

### Technical Problem

The present invention, for example, is devised in consideration of the above-described problems, and an object thereof is to provide an image processing apparatus, an imaging apparatus, an image processing method, and a program, in a configuration in which a left-eye image and a right-eye image used for displaying a three-dimensional image or a two-dimensional panoramic image is generated from a plurality of images captured while a camera is moved, capable of performing an optimal image generating process in accordance with the rotation or the movement state of the camera and, in a case where the 2D panoramic image or the 3D image cannot be generated, warning a user of such a situation.

### Solution to Problem

According to a first aspect of the present invention, there is provided an image processing apparatus including: an image composing unit that receives a plurality of images captured from mutually different positions as inputs and generates a composition image by connecting stripped areas that are cut out from each of the images, wherein the image composing unit determines one processing aspect based on movement information of an imaging apparatus at the time of capturing an image from among (a) a composition image generating process of a left-eye composition image and a right-eye composition image that are used for displaying a three-dimensional image, (b) a composition image generating process of a two-dimensional panoramic image, and (c) stopping composition image generating and performs the determined process.

In addition, in an embodiment of the image processing apparatus of the present invention, the above-described image processing apparatus further includes: a turning momentum detecting unit that acquires or calculates turning momentum (θ) of the imaging apparatus at the time of capturing an image; and a translational momentum detecting unit that acquires or calculates translational momentum (t) of the imaging apparatus at the time of capturing an image, wherein the image composing unit determines the processing aspect based on the turning momentum (θ) detected by the turning momentum detecting unit and the translational momentum (t) detected by the translational momentum detecting unit.

Furthermore, in an embodiment of the image processing apparatus of the present invention, the above-described image processing apparatus further includes an output unit that presents a warning or a notification to a user in accordance with information of the determination of the image composing unit.

In addition, in an embodiment of the image processing apparatus of the present invention, the above-described image composing unit stops the composition image generating process of the three-dimensional image and the two-dimensional panoramic image in a case where the turning momentum (θ) detected by the turning momentum detecting unit is zero.

Furthermore, in an embodiment of the image processing apparatus of the present invention, the above-described image composing unit performs one of the composition image generating process of a two-dimensional panoramic image and the stopping composition image generating in a case where the turning momentum (θ) detected by the turning momentum detecting unit is not zero, and the translational momentum (t) detected by the translational momentum detecting unit is zero.

In addition, in an embodiment of the image processing apparatus of the present invention, the above-described image composing unit performs one of the composition image generating process of a three-dimensional image and the composition image generating process of a two-dimensional panoramic image in a case where the turning momentum (θ) detected by the turning momentum detecting unit is not zero, and the translational momentum (t) detected by the translational momentum detecting unit is not zero.

Furthermore, in an embodiment of the image processing apparatus of the present invention, in a case where case where the turning momentum (θ) detected by the turning momentum detecting unit is not zero, and the translational momentum (t) detected by the translational momentum detecting unit is not zero, the image composing unit performs a process in which LR images of the 3D image, which are to be generated, are reversely set in a case where θ·t<0 and in a case where θ·t>0.

In addition, in an embodiment of the image processing apparatus of the present invention, the above-described turning momentum detecting unit is a sensor that detects the turning momentum of the image processing apparatus.

Furthermore, in an embodiment of the image processing apparatus of the present invention, the translational momentum detecting unit is a sensor that detects the translational momentum of the image processing apparatus.

In addition, in an embodiment of the image processing apparatus of the present invention, the above-described turning momentum detecting unit is an image analyzing unit that detects the turning momentum at the time of capturing an image by analyzing captured images.

Furthermore, in an embodiment of the image processing apparatus of the present invention, the above-described translational momentum detecting unit is an image analyzing unit that detects the translational momentum at the time of capturing an image by analyzing captured images.

In addition, according to a second aspect of the present invention, there is provided an imaging apparatus including: an imaging unit; and an image processing unit that performs the image processing according to any one of claims 1 to 11.

Furthermore, according to a third aspect of the present invention, there is provided an image processing method that is performed in an image processing apparatus including: receiving a plurality of images captured from mutually different positions as inputs and generating a composition image by connecting stripped areas that are cut out from each of the images by using an image composing unit, wherein, in the receiving of a plurality of images and generating of a composition image, one processing aspect is determined based on movement information of an imaging apparatus at the time of capturing an image from among (a) a composition image generating process of a left-eye composition image and a right-eye composition image that are used for displaying a three-dimensional image, (b) a composition image generating process of a two-dimensional panoramic image, and (c) stopping composition image generating, and the determined process is performed.

In addition, according to a fourth aspect of the present invention, there is provided a program that causes an image processing apparatus to perform image processing, the program causing an image composing unit to perform receiving a plurality of images captured from mutually different positions as inputs and generating a composition image by connecting stripped areas that are cut out from each of the images, wherein, in the receiving of a plurality of images and generating of a composition image, one processing aspect is determined based on movement information of an imaging apparatus at the time of capturing an image from among (a) a composition image generating process of a left-eye composition image and a right-eye composition image that are used for displaying a three-dimensional image, (b) a composition image generating process of a two-dimensional panoramic image, and (c) stopping composition image generating, and the determined process is performed.

In addition, the program according to the present invention, for example, is a program that can be provided as a storage medium in a computer-readable form for an information processing apparatus or a computer system that can execute various program codes or a communication medium. By providing such a program in a computer-readable form, a process according to the program is realized on the information processing apparatus or the computer system.

Other features and advantages of the present invention will become more apparent by describing in detail exemplary embodiments with reference to the attached drawings. In addition, a system described in this specification is a logical aggregated configuration of a plurality of apparatuses, and the apparatuses of each configuration are not limited to be disposed inside a same casing.

### Advantageous Effects of Invention

According to the configuration of an embodiment of the present invention, in a configuration in which a two-dimensional panoramic image or images for displaying a three-dimensional image are generated by connecting stripped areas cut out from a plurality of images, a configuration is realizes in which a composition image that can be generated is generated based on the movement of a camera, and the determined composition image is generated. In a configuration in which a two-dimensional panoramic image or a left-eye composition image and a right-eye composition image used for displaying a three-dimensional image are generated by connecting striped areas cut out from a plurality of images, the information of the movement of the imaging apparatus at the time of capturing an image is analyzed, it is determined whether a two-dimensional panoramic image or a three-dimensional image can be generated, and the process of generating a composition image that can be generated is performed. In accordance with the turning momentum (θ) and the translational momentum (t) of the camera at the time of capturing an image, one processing aspect is determined from among (a) a composition image generating process of a left-eye composition image and a right-eye composition image that are used for displaying a three-dimensional image, (b) a composition image generating process of a two-dimensional panoramic image, and (c) stopping composition image generating, and the determined process is performed. In addition, a notification of the content of the processing or a warning is presented to a user.

### BRIEF DESCRIPTION OF DRAWINGS

FIG. 1 is a diagram that illustrates a panoramic image generating process.

FIG. 2 is a diagram that illustrates the process of generating a left-eye image (L image) and a right-eye image (R image) that are used for displaying a three-dimensional (3D) image.

FIG. 3 is a diagram that illustrates a principle of generating a left-eye image (L image) and a right-eye image (R image) used for displaying a three-dimensional (3D) image.

FIG. 4 is a diagram that illustrates a reverse model using a virtual imaging surface.

FIG. 5 is a diagram that illustrates a model for a process of capturing a panoramic image (3D panoramic image).

FIG. 6 is a diagram that illustrates an image captured in a panoramic image (3D panoramic image) capturing process and an example of the setting of strips of a left-eye image and a right-eye image.

FIG. 7 is a diagram that illustrates examples of a stripped area connecting process and the process of generating a 3D left-eye composition image (3D panoramic L image) and a 3D right-eye composition image (3D panoramic R image).

FIG. 8 is a diagram that illustrates an example of an ideal camera moving process in a case where a 3D image or a 2D panoramic image is generated by cutting out stripped areas from a plurality of images that are consecutively imaged while a camera is moved.

FIG. 9 is a diagram that illustrates an example of a camera moving process for which a 3D image or a 2D panoramic image cannot be generated by cutting out stripped areas from a plurality of images that are consecutively imaged while a camera is moved.

FIG. 10 is a diagram that illustrates a configuration example of an imaging apparatus that is an image processing apparatus according to an embodiment of the present invention.

FIG. 11 is a diagram that shows a flowchart illustrating the sequence of an image capturing and composing process that is performed by an image processing apparatus according to the present invention.

FIG. 12 is a diagram that shows a flowchart illustrating the sequence of a process determining process that is performed by an image processing apparatus according to the present invention.

FIG. 13 is a diagram that illustrates detection information detected by a turning momentum detecting unit 211 and a translational momentum detecting unit 212 and processes determined in accordance with the detection information together.

### DESCRIPTION OF EMBODIMENTS

Hereinafter, an image processing apparatus, an imaging apparatus, an image processing method, and a program according to the present invention will be described with reference to the drawings. The description will be presented in the following order of items.
1. Basic Configuration for Process of Generating Panoramic Image and Three-dimensional (3D) Image
2. Problem in Generating 3D Image Using Stripped Areas of Plurality of Images Captured While Camera Is Moved
3. Configuration Example of Image Processing Apparatus According to Present Invention
4. Sequence of Image Capturing and Image Processing
5. Specific Configuration Example of Turning Momentum Detecting Unit and Translational Momentum Detecting Unit
6. Example of Switching Between Processes Based On Turning Momentum and Translational Momentum

### 1. BASIC CONFIGURATION FOR PROCESS OF GENERATING PANORAMIC IMAGE AND THREE-DIMENSIONAL (3D) IMAGE

The present invention relates to a process of generating a left-eye image (L image) and a right-eye image (R image) used for displaying a three-dimensional (3D) image by connecting areas (stripped areas) of images that are cut out in the shape of a strip by using a plurality of the images consecutively captured while an imaging apparatus (camera) is moved.

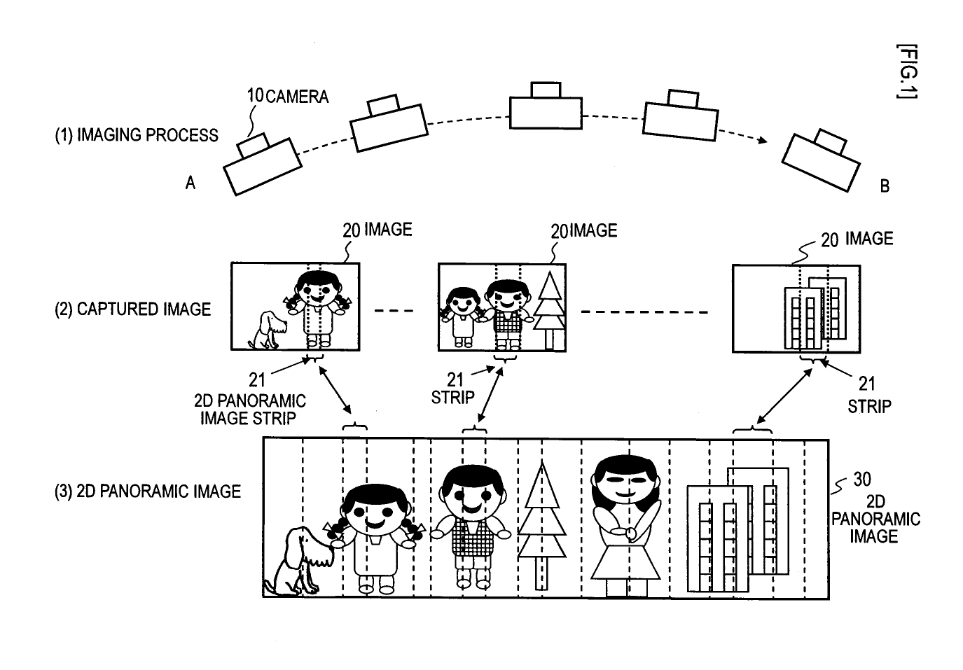

Cameras capable of generating a two-dimensional panoramic image (2D panoramic image) using a plurality of images that are consecutively captured while moving the cameras have already been realized and used. First, a process of generating a panoramic image (2D panoramic image) that is generated as a two-dimensional composition image will be described with reference to FIG. 1. In FIG. 1, diagrams that illustrate (1) Imaging Process, (2) Captured Image, and (3) Two-dimensional Composition Image (2D panoramic image) are represented.

A user sets a camera 10 to a panorama photographing mode, holds the camera 10 in his hand, and, as illustrated in FIG. 1(1), moves the camera from the left side (point A) to the right side (point B) with the shutter being pressed. When the user' s pressing of the shutter under the setting of the panorama photographing mode is detected, the camera 10 performs consecutive image capturing operations. For example, about 10 to 100 images are consecutively captured.

Such images are images 20 that are illustrated in FIG. 1(2). The plurality of images 20 are images that are consecutively captured while the camera 10 is moved and are images from mutually different viewpoints. For example, 100 images 20 captured from mutually different viewpoints are sequentially recorded in a memory. A data processing unit of the camera 10 reads out a plurality of images 20 that are illustrated in FIG. 1(2) from the memory, cuts out stripped areas that are used for generating a panoramic image from the images, and performs the process of connecting the cut-out stripped areas, thereby generating a 2D panoramic image 30 that is illustrated in FIG. 1(3).

The 2D panoramic image 30 illustrated in FIG. 1(3) is a two-dimensional (2D) image and is an image that is horizontally long by cutting out parts of captured images and connecting the parts. Dotted lines represented in FIG. 1(3) illustrates a connection portions of the images. The cut-out area of each image 20 will be referred to as a stripped area.

The image processing apparatus or the imaging apparatus according to the present invention performs an image capturing process as illustrated in FIG. 1, in other words, as illustrated in FIG. 1(1), generates a left-eye image (L image) and a right-eye image (R image) used for displaying a three-dimensional (3D) image using a plurality of images that are consecutively captured while the camera is moved.

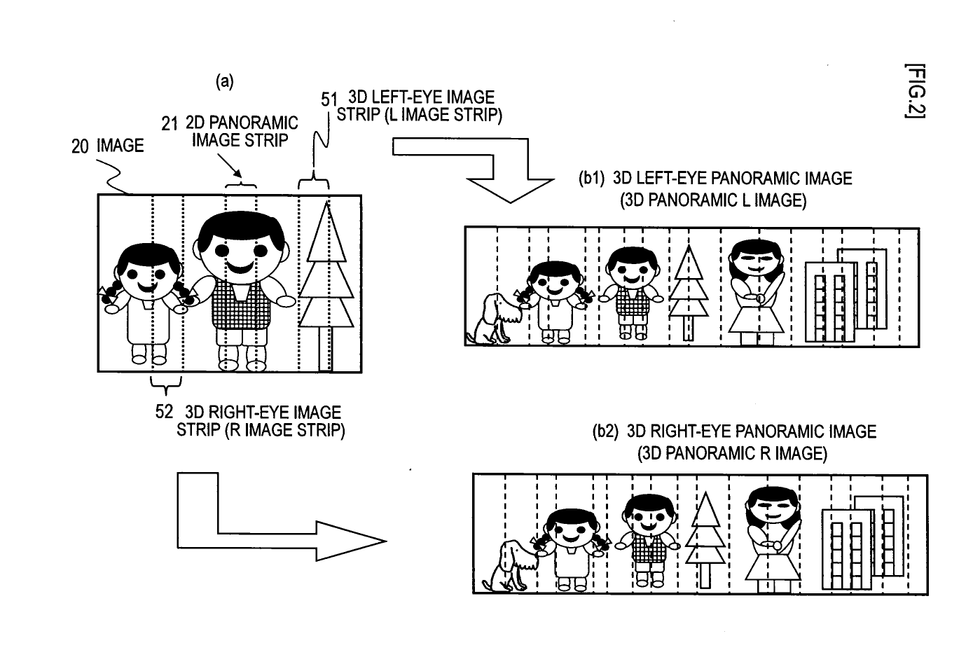

A basic configuration for the process of generating the left-eye image (L image) and the right-eye image (R image) will be described with reference to FIG. 2.

FIG. 2(a) illustrates one image 20 that is captured in a panorama photographing process illustrated in FIG. 1(2).

The left-eye image (L image) and the right-eye image (R image) that are used for displaying a three-dimensional (3D) image, as in the process of generating a 2D panoramic image described with reference to FIG. 1, are generated by cutting out predetermined striped areas from the image 20 and connecting the stripped areas.

However, the stripped areas that are set as cut-out areas are located at different positions for the left-eye image (L image) and the right-eye image (R image).

As illustrated in FIG. 2(a), there is a difference in the cut-out positions of a left-eye image strip (L image strip) 51 and a right-eye image strip (R image strip) 52. Although only one image 20 is illustrated in FIG. 2, for each of a plurality of images captured with the camera moving, which are illustrated in FIG. 1(2), left-eye image strips (L image strips) and right-eye strips (R image strips) that are located at different cut-out positions are set.

Thereafter, by collecting and connecting only the left-eye image strips (L image strips), a 3D left-eye panoramic image (3D panoramic L image) illustrated in FIG. 2(b1) can be generated.

In addition, by collecting and connecting only the right-eye image strips (R image strips), a 3D right-eye panoramic image (3D panoramic R image) illustrated in FIG. 2(b2) can be generated.

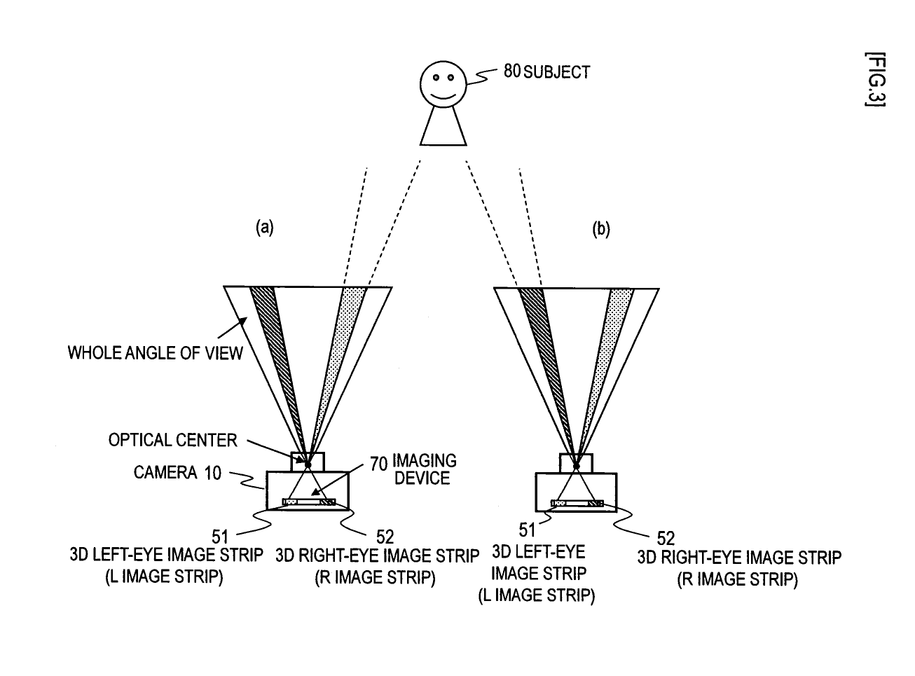

As above, by connecting the strips, of which the cut-out positions are differently set, that are acquired from a plurality of images captured with the camera moving, it is possible to generate a left-eye image (L image) and a right-eye image (R image) that are used for displaying a three-dimensional (3D) image. This principle will be described with reference to FIG. 3.

FIG. 3 illustrates a situation in which a subject 80 is photographed at two capturing positions (a) and (b) by moving the camera 10. At position (a), as the image of the subject 80, an image seen from the left side is recorded in the left-eye image strip (L image strip) 51 of an imaging device 70 of the camera 10. Next, as the image of the subject 80 at position (b) to which the camera 10 is moved, an image seen from the right side is recorded in the right-eye image strip (R image strip) 52 of the imaging device 70 of the camera 10.

As above, images of the same subject seen from mutually different viewpoints are recorded in predetermined areas (strip areas) of the imaging device 70.

By individually extracting these, in other words, by collecting and connecting only the left-eye image strips (L image strips), a 3D left-eye panoramic image (3D panoramic L image) illustrated in FIG. 2(b1) is generated, and, by collecting and connecting only the right-eye image strips (R image strips), a 3D right-eye panoramic image (3D panoramic R image) illustrated in FIG. 2(b2) is generated.

In FIG. 3, in order to easy understanding, a movement setting is represented in which the camera 10 crosses the subject from the left side of the subject 80 to the right side, the movement of the camera 10 crossing the subject 80 is not essential. As long as images seen from mutually different viewpoints can be recorded in predetermined areas of the imaging device 70 of the camera 10, a left-eye image and a right-eye image that are used for displaying a 3D image can be generated.

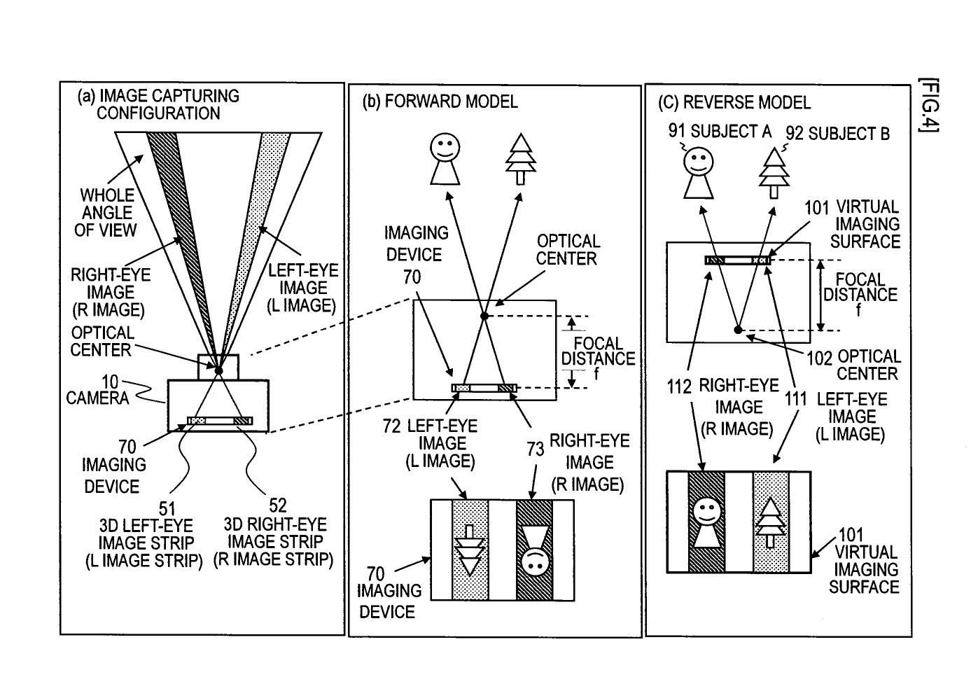

Next, a reverse model using a virtual imaging surface used in the description presented below will be described with reference to FIG. 4. In FIG. 4, drawings of (a) image capturing configuration, (b) forward model, and (c) reverse model are represented.

The image capturing configuration illustrated in FIG. 4(a) illustrates a process configuration at a time when a panoramic image, which is similar to that described with reference to FIG. 3, is captured.

FIG. 4(b) illustrates an example of an image that is actually captured into the imaging device 70 disposed inside the camera 10 in the capturing process illustrated in FIG. 4(a).

In the imaging device 70, as illustrated in FIG. 4(b), a left-eye image 72 and a right-eye image 73 are recorded in a vertically reversed manner. In a case where description is made using such a reversed image, in the description presented below, the description will be made using the reverse model illustrated in FIG. 4(c).

This reverse model is a model that is frequently used in an explanation of an image in an imaging apparatus or the like.

In the reverse model that is illustrated in FIG. 4(c), it is assumed that a virtual imaging device 101 is set in front of the optical center 102 corresponding to the focal point of the camera, and a subject image is captured into the virtual imaging device 101. As illustrated in FIG. 4(c), in the virtual imaging device 101, a subject A91 located on the left side in front of the camera is captured into the left side, a subject B92 located on the right side in front of the camera is captured into the right side, and the images are set not to be vertically reversed, whereby the actual positional relation of the subjects is directly reflected. In other words, an image formed on the virtual imaging device 101 represents the same image data as that of an actually captured image.

In the description presented below, the reverse model using this virtual imaging device 101 will be used.

As illustrated in FIG. 4(c), on the virtual imaging device 101, a left-eye image (L image) 111 is captured into the right side on the virtual imaging device 101, and a right-eye image (R image) 112 is captured into the left side on the virtual imaging device 101.

### 2. PROBLEM IN GENERATING 3D IMAGE OR 2D PANORAMIC IMAGE USING STRIPPED AREAS OF PLURALITY OF IMAGES CAPTURED WHILE CAMERA IS MOVED

Next, problems in generating a 3D image or a 2D panoramic image using stripped areas of plurality of images captured while a camera is moved will be described.

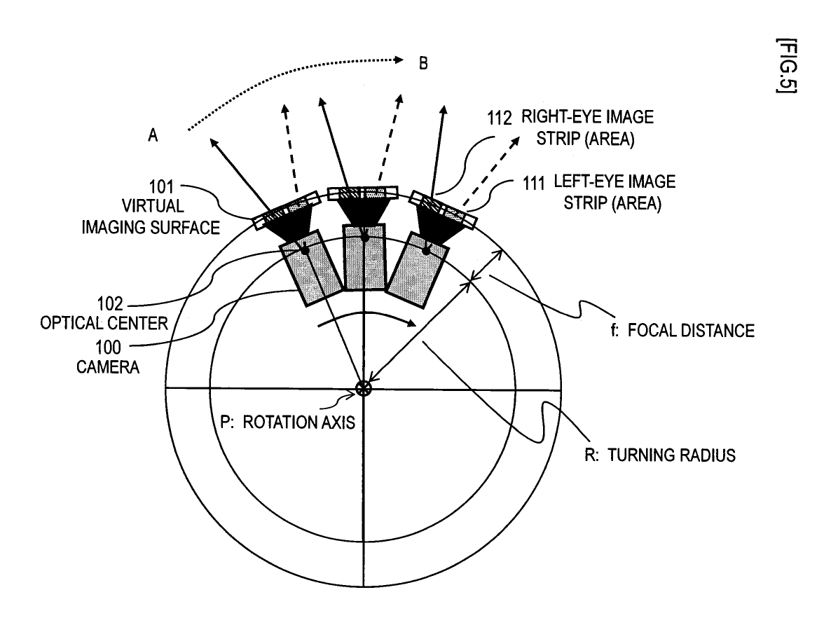

As a model for the process of capturing a panoramic image (2D/3D panoramic image), a capturing model that is illustrated in FIG. 5 will be assumed. As illustrated in FIG. 5, the cameras 100 are placed such that the optical centers 102 of the cameras 100 are set to positions separated away from the rotation axis P, which is the rotation center, by a distance R (turning radius).

A virtual imaging surface 101 is set to the outer side of the rotation axis P from the optical center 102 by a focal distance f.

In such settings, the cameras 100 are rotated around the rotation axis P in a clockwise direction (the direction from A to B), and a plurality of images are consecutively captured.

In each capturing point, other than the strips used for generating a 2D panoramic image, images of a left-eye image strip 111 and a right-eye image strip 112 are recorded on the virtual imaging device 101.

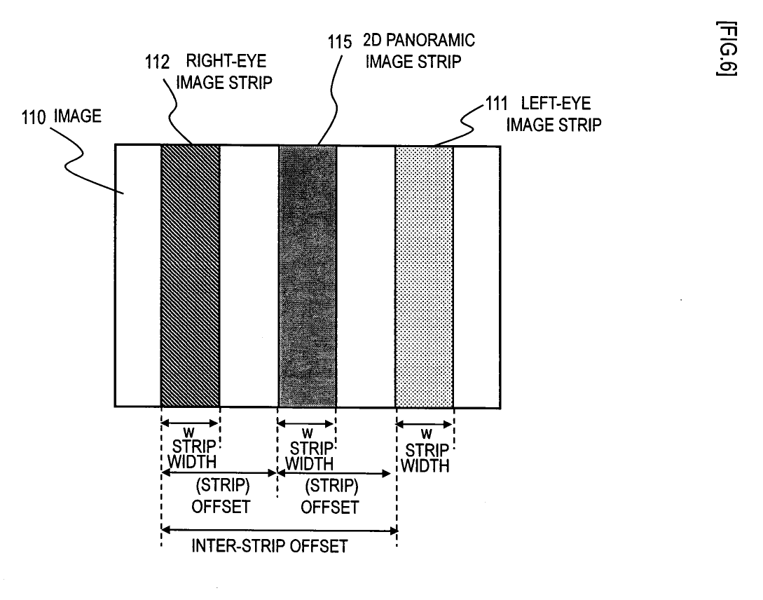

For example, the recorded image has a configuration as illustrated in FIG. 6.

FIG. 6 illustrates an image 110 that is captured by the camera 100. In addition, this image 110 is the same as the image formed on the virtual imaging surface 101.

In the image 110, as illustrated in FIG. 6, an area (stripped area) that is offset to the left side from the center portion of the image and is cut out in a strip shape is set as the right-eye image strip 112, and an area (stripped area) that is offset to the right side from the center portion of the image and is cut out in a strip shape is set as the left-eye image strip 111.

In addition, in FIG. 6, a 2D panoramic image strip 115 that is used when a two-dimensional (2D) panoramic image is generated is illustrated.

As illustrated in FIG. 6, a distance between the 2D panoramic image strip 115 used for a two-dimensional composition image and the left-eye image strip 111 and a distance between the 2D panoramic image strip 115 and the right-eye image strip 112 are defined as “offsets” or “strip offsets”=d1 and d2.

In addition, a distance between the left-eye image strip 111 and the right-eye image strip 112 is defined as “inter-strip offset”=D.

Furthermore, the inter-strip offset=(strip offset)×2, and D=d1+d2.

A strip width w is a width w that is common to all the 2D panoramic image strip 115, the left-eye image strip 111, and the right-eye image strip 112. This strip width is changed in accordance with the moving speed of the camera and the like. In a case where the moving speed of the camera is high, the strip width w is widened, and, in a case where the moving speed of the camera is low, the strip width w is narrowed. This point will be described further in a later stage.

The strip offset or the inter-strip offset may be set to various values. For example, in a case where the strip offset is set to large, the disparity between the left-eye image and the right-eye image is large, and, in a case where the strip offset is set to be small, the disparity between the left-eye image and the right-eye image is small.

In a case where the strip offset=0, left-eye image strip 111=right-eye image strip 112=2D panoramic image strip 115.

In such a case, a left-eye composition image (left-eye panoramic image) that is acquired by composing the left-eye image strips 111 and a right-eye composition image (right-eye panoramic image) that is acquired by composing the right-eye image strips 112 are completely the same image, that is, an image that is the same as the two-dimensional panoramic image acquired by composing the 2D panoramic image strips 115 and cannot be used for displaying a three-dimensional image.

In the description presented below, the lengths of the strip width w, the strip offset, and the inter-strip offset are described as values that are defined as the numbers of pixels.

The data processing unit disposed inside the camera 100 acquires motion vectors between images that are consecutively captured while the camera 100 is moved, and while the strip areas are aligned such that the patterns of the above-described strip areas are connected together, the data processing unit sequentially determines strip areas cut out from each image and connects the strip areas cut out from each image.

In other words, a left-eye composition image (left-eye panoramic image) is generated by selecting only the left-eye image strips 111 from the images and connecting and composing the selected left-eye image strips, and a right-eye composition image (right-eye panoramic image) is generated by selecting only the right-eye image strips 112 from the images and connecting and composing the selected right-eye image strips.

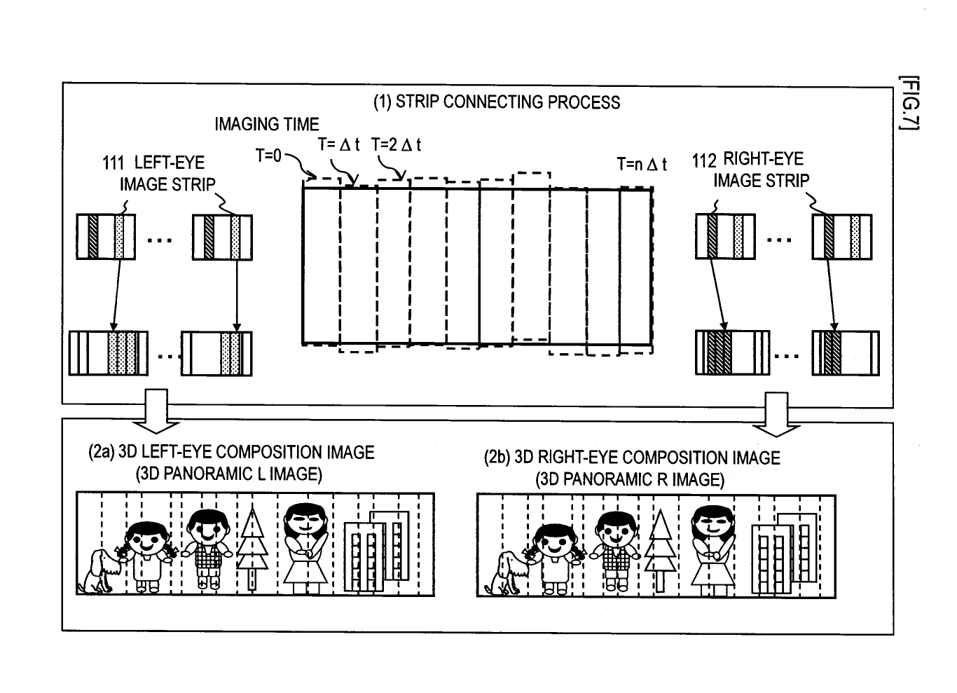

FIG. 7(1) is a diagram that illustrates an example of a strip area connecting process. It is assumed that a capturing time interval between images is Δt, and n+1 images are captured between a capturing time T=0 to nΔt. Strip areas extracted from the n+1 images are connected together.

However, in a case where a 3D left-eye composition image (3D panoramic L image) is generated, only the left-eye image strips (L image strips) 111 are extracted and connected. In addition, in a case where a 3D right-eye composition image (3D panoramic R image) is generated, only the right-eye image strips (R image strips) 112 are extracted and connected.

As above, by collecting and connecting only the left-eye image strips (L image strips) 111, the 3D left-eye composition image (3D panoramic L image) illustrated in FIG. 7 (2a) is generated.

In addition, by collecting and connecting only the right-eye image strips (R image strips) 112, the 3D right-eye composition image (3D panoramic R image) illustrated in FIG. 7(2b) is generated.

As described with reference to FIGS. 6 and 7, by composing the 2D panoramic image strips 115 set in the image 100, the two-dimensional panoramic image is generated. In addition, by joining the stripped areas offset to the right side from the center of the image 100, the 3D left-eye composition image (3D panoramic L image) illustrated in FIG. 7(2a) is generated.

In addition, by joining the stripped areas offset to the left side from the center of the image 100, the 3D right-eye composition image (3D panoramic R image) illustrated in FIG. 7(2b) is generated.

In these two images, as described above with reference to FIG. 3, while basically the same subject is imaged, the same subject is imaged from mutually different positions, whereby disparity occurs. By displaying the two images having disparity therebetween in a display apparatus that can display a 3D (stereoscopic) image, the subject as the imaging target can be displayed in a stereoscopic manner.

In addition, as display types of a 3D image, there are various types.

For example, there are a 3D image displaying type corresponding to a passive glass type in which images observed by the left and right eyes are separated from each other by using polarizing filters or color filters, a 3D image displaying type corresponding to an active glass type in which observed images are separated in time alternately for the left and right eyes by alternately opening/closing left and right liquid crystal shutters, and the like.

The left-eye image and the right-eye image that are generated by the above-described strip connecting process can be applied to each one of such types.

As described above, by generating the left-eye image and the right-eye image by cutting out stripped areas from each one of a plurality of images that are consecutively captured while a camera is moved, the left-eye image and the right-eye image can be generated that are observed from mutually-different viewpoints, that is, from the left-eye position and the right-eye position.

However, although strip areas are cut out from each one of a plurality of images that are consecutively captured while a camera is moved, there is a case where such a 3D image or a 2D panoramic image cannot be generated.

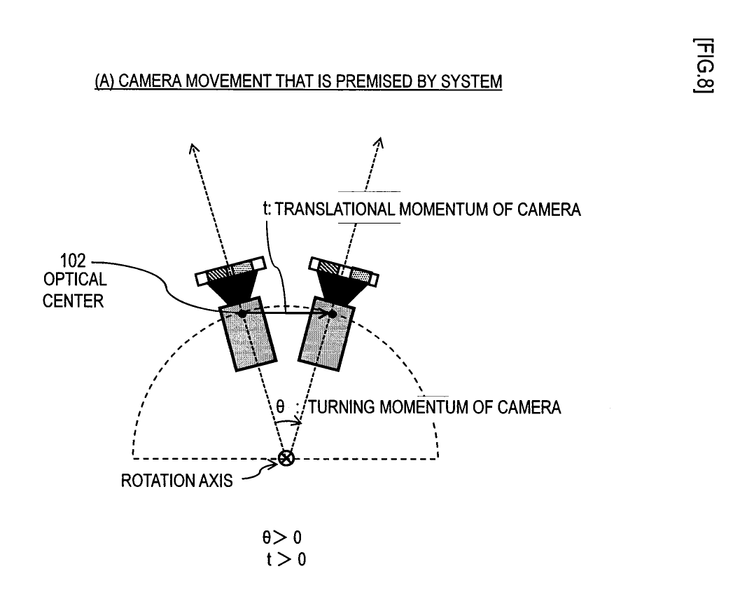

More specifically, for example, as illustrated in FIG. 8(A), in a case where the camera is moved in an arc shape such that the optical axes do not intersect with each other, strips used for generating a 3D image or a 2D panoramic image can be cut out.

However, there is a case where strips used for generating a 3D image or a 2D panoramic image cannot be cut out from images that are captured in accordance with a movement other than such a movement.

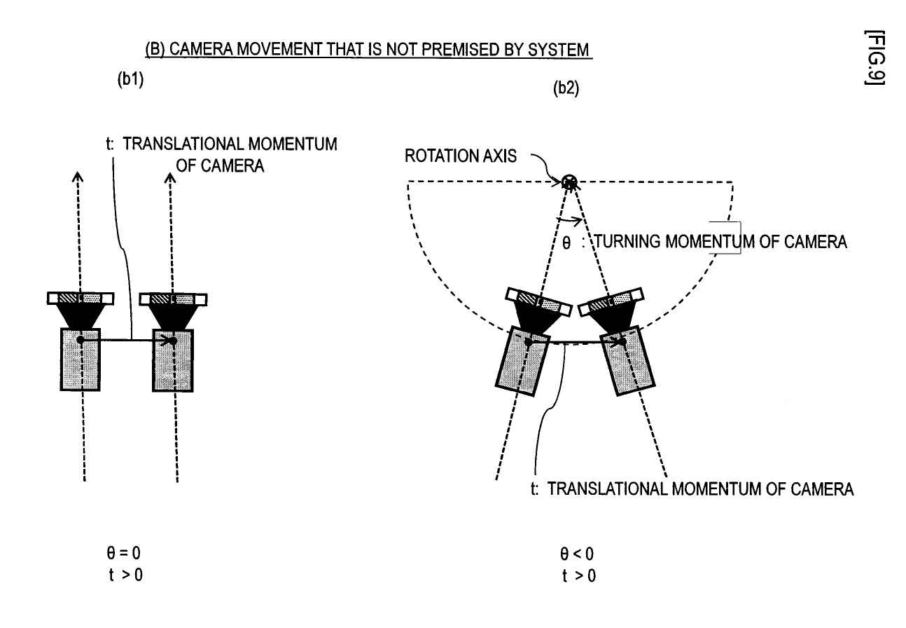

For example, such a case is a case (b1) illustrated in FIG. 9 in which a camera makes a translational motion not accompanying turning or a case (b2) in which a camera is moved along an arc shape such that the optical axes intersect with each other in accordance with the movement of the camera.

In a case where a user moves the camera through a camera swinging operation or the like, it is difficult to move the camera so as to draw an ideal track as illustrated in FIG. 8, and the movement as illustrated in FIG. 9(b1) or 9(b2) may be made.

An object of the present invention is to provide an image processing apparatus, an imaging apparatus, an image processing method, and a program capable of performing an optimal image processing process in accordance with a turning motion or a translational motion of a camera in a case where an image is captured through such various forms of movement and warning a user of the situation in a case where a 2D panoramic image or a 3D image cannot be generated.

Hereinafter, this process will be described in detail.

### 3. CONFIGURATION EXAMPLE OR IMAGE PROCESSING APPARATUS ACCORDING TO PRESENT INVENTION

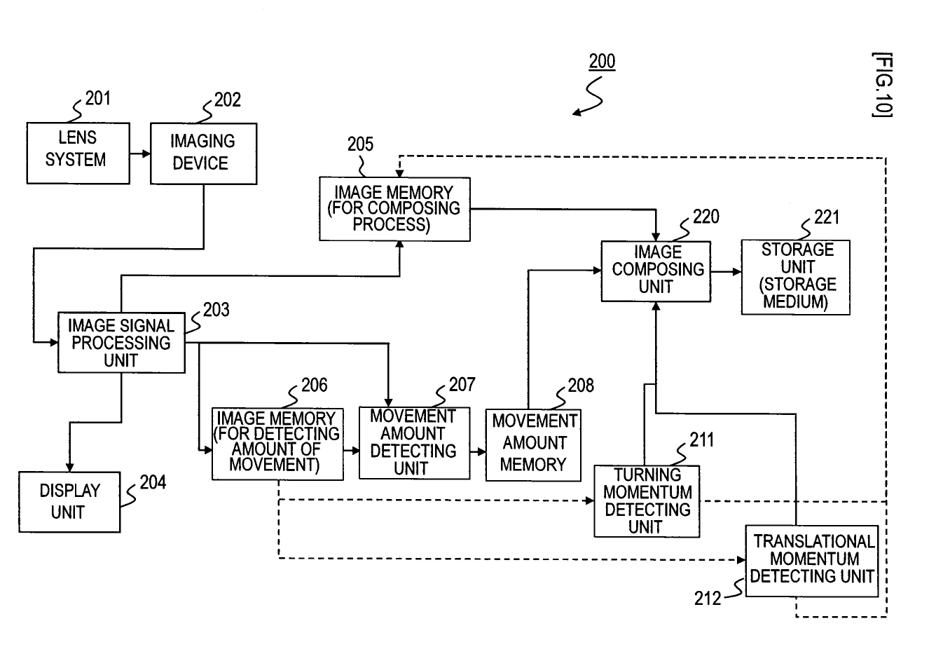

First, a configuration example of an imaging apparatus as an image processing apparatus according to an embodiment of the present invention will be described with reference to FIG. 10.

An imaging apparatus 200 illustrated in FIG. 10 corresponds to the camera 10 that has been described with reference to FIG. 1 and, for example, has a configuration that allows a user to consecutively capture a plurality of images in a panorama photographing mode with the imaging apparatus held in his hand.

Light transmitted from a subject is incident to an imaging device 202 through a lens system 201. The imaging device 202, for example, is configured by a CCD (Charge Coupled Device) or a CMOS (Complementary Metal Oxide Semiconductor) sensor.

The subject image that is incident to the imaging device 202 is converted into an electrical signal by the imaging device 202. In addition, although not illustrated in the figure, the imaging device 202 includes a predetermined signal processing circuit, further converts an electrical signal converted by the signal processing circuit, and supplies the digital image data to an image signal processing unit 203.

The image signal processing unit 203 performs image signal processing such as gamma correction or contour enhancement correction and displays an image signal as a result of the signal processing on a display unit 204.

The image signal as the result of the processing performed by the image signal processing unit 203 is supplied to units including an image memory (for a composing process) 205 that is an image memory used for a composing process, an image memory (for detecting the amount of movement) 206 that is used for detecting the amount of movement between images that are consecutively captured, and a movement amount calculating unit 207 that calculates the amount of movement between the images.

The movement amount detecting unit 207 acquires an image of a frame that is one frame before, which is stored in the image memory (for detecting the amount of movement) 206, together with the image signal that is supplied from the image signal processing unit 203 and detects the amount of movement between the current image and the image of the frame that is one frame before. The number of pixels moved between the images is calculated, for example, by performing a process of matching pixels configuring two images that are consecutively captured, in other words, a matching process in which captured areas of the same subject are determined. In addition, basically, the process is performed by assuming that the subject is stopped. In a case where there is a moving subject, although a motion vector other than a motion vector of the whole image is detected, the process is performed while the motion vector corresponding to the moving subject is not set as a detection target. In other words, a motion vector (GMV: global motion vector) corresponding to the movement of the whole image that occurs in accordance with the movement of the camera is detected.

In addition, for example, the amount of movement is calculated as the number of moved pixels. The amount of movement of image n is calculated by comparing image n and image n−1 that precedes image n, and the detected amount of movement (number of pixels) is stored in the movement amount memory 208 as an amount of movement corresponding to image n.

In addition, the image memory (for the composing process) 205 is a memory for the process of composing the images that have been consecutively captured, in other words, a memory in which images used for generating a panoramic image are stored. Although this image memory (for the composing process) 205 may be configured such that all the images, for example, n+1 images that are captured in the panorama photographing mode are stored therein, for example, the image memory 205 may be set such that end portions of an image is clipped out, and only a center area of the image from which strip areas that are necessary for generating a panoramic image is selected so as to be stored. Through such setting, a required memory capacity can be reduced.

Furthermore, in the image memory (for the composing process) 205, not only captured image data but also capturing parameters such as a focal distance [f] and the like are recorded as attribute information of an image in association with the image. The parameters are supplied to an image composing unit 220 together with the image data.

Each one of the turning momentum detecting unit 211 and the translational momentum detecting unit 212, for example, is configured as a sensor that is included in the imaging apparatus 200 or an image analyzing unit that analyzes a captured image.

In a case where the turning momentum detecting unit 211 is configured as a sensor, it is a posture detecting sensor that detects the posture of the camera called pitch/roll/yaw of the camera. The translational momentum detecting unit 212 is a movement detecting sensor that detects a movement of the camera with respect to a world coordinate system as the movement information of the camera. The detection information detected by the turning momentum detecting unit 211 and the detection information detected by the translational momentum detecting unit 212 are supplied to the image composing unit 220.

In addition, the detection information detected by the turning momentum detecting unit 211 and the detection information detected by the translational momentum detecting unit 212 may be configured to be stored in the image memory (for the composing process) 205 as the attribute information of the captured image together with the captured image when an image is captured, and the detection information may be configured to be input together with an image as a composition target to the image composing unit 220 from the image memory (for the composing process) 205.

Furthermore, the turning momentum detecting unit 211 and the translational momentum detecting unit 212 may be configured not by sensors but by the image analyzing unit that performs an image analyzing process. The turning momentum detecting unit 211 and the translational momentum detecting unit 212 acquires information that is similar to the sensor detection information by analyzing a captured image and supplies the acquired information to the image composing unit 220. In such a case, the turning momentum detecting unit 211 and the translational momentum detecting unit 212 receive image data from the image memory (for detecting the amount of movement) 206 as an input and perform image analysis. A specific example of such a process will be described in a later stage.

After the capturing process ends, the image composing unit 220 acquires an image from the image memory (for the composing process) 205, further acquires the other necessary information, and performs an image composing process in which stripped areas are cut out from the image, which is acquired from the image memory (for the composing process) 205, and connecting the stripped areas. Through this process, a left-eye composition image and a right-eye composition image are generated.

After the end of the capturing process, the image composing unit 220 receives the amount of movement corresponding to each image stored in the movement amount memory 208 and the detection information (the information that is acquired through sensor detection or image analysis) detected by the turning momentum detecting unit 211 and the translational momentum detecting unit 212 as inputs together with a plurality of images (or partial images) that are stored during the capturing process from the image memory (for the composing process) 205.

The image composing unit 220 cuts out strips from a plurality of images that has been consecutively captured using the input information and a connection process thereof, thereby generating a left-eye composition image (left-eye panoramic image) and a right-eye composition image (right-eye panoramic image) as a 2D panoramic image or a 3D image. In addition, the image composing unit 220 performs a compression process such as JPEG for each image and then stores the compressed image in a recording unit (recording medium) 221.

In addition, the image composing unit 220 receives the detection information (the information acquired through sensor detection or image analysis) detected by the turning momentum detecting unit 211 and the translational momentum detecting unit 212 as inputs and determines the processing aspect.

More specifically, the image composing unit 220 performs one of the following processes including:
(a) generation of a 3D panoramic image;
(b) generation of a 2D panoramic image; and
(c) no generation of both 3D and 2D panoramic images.

In addition, in the case where (a) generation of a 3D panoramic image is performed, reversal of LR images (the left-eye image and the right-eye image) or the like may be performed in accordance with the detection information.

Furthermore, in a case where (c) no generation of both 3D and 2D panoramic images is performed, a warning output process for a user and the like are performed.

In addition, a specific processing example thereof will be described in detail in a later stage.

The recording unit (recording medium) 221 stores composition images that are composed by the image composing unit 220, that is, the left-eye composition image (left-eye panoramic image) and a right-eye composition image (right-eye panoramic image).

The recording unit (recording medium) 221 may be any type of recording medium as long as it is a recording medium on which a digital signal can be recorded, and, for example, a recording medium such as a hard disk, a magneto-optical disk, a DVD (Digital Versatile Disc), an MD (Mini Disk), or a semiconductor memory can be used.

In addition, although not illustrated in FIG. 10, other than the configuration illustrated in FIG. 10, the imaging apparatus 200 includes an input operation unit that is used for performing various inputs for setting the shutter and the zoom that can be operated by a user, a mode setting process, and the like, a control unit that controls the process performed by the imaging apparatus 200, and a storage unit (memory) that stores a processing program and parameters of any other constituent unit, parameters, and the like.

The process of each constituent unit of the imaging apparatus 200 that is illustrated in FIG. 10 and the input/output of data are performed under the control of the control unit disposed inside the imaging apparatus 200. The control unit reads out a program that is stored in a memory disposed inside the imaging apparatus 200 in advance and performs overall control of the processes such as acquisition of a captured image, data processing, generation of a composition image, a process of recording the generated composition image, a display process, and the like that are performed in the imaging apparatus 200 in accordance with the program.

### 4. SEQUENCE OF IMAGE CAPTURING AND IMAGE PROCESSING

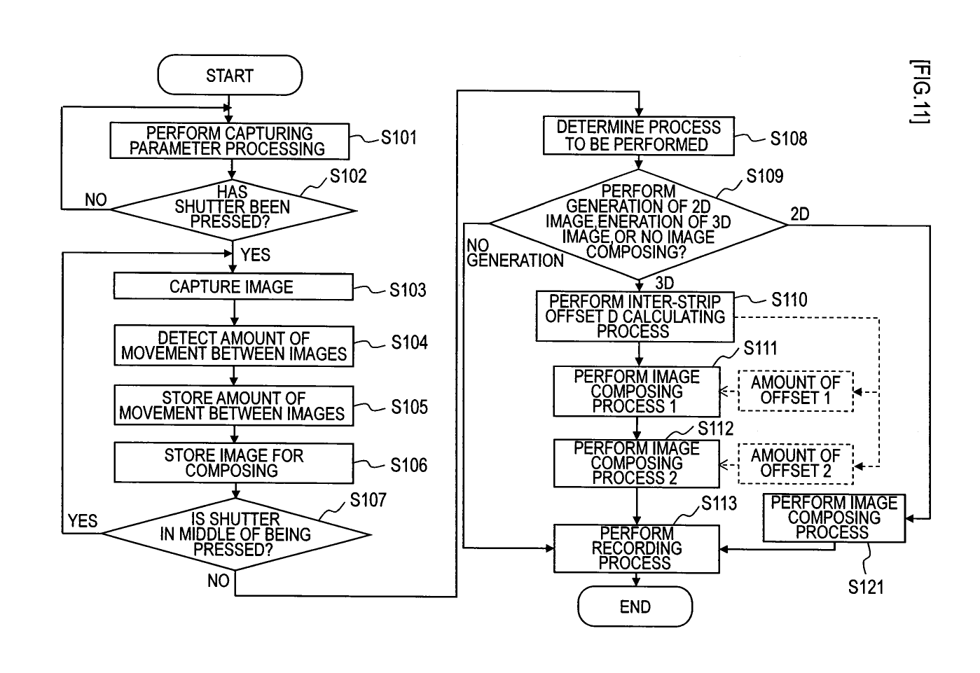

Next, an example of the sequence of image capturing and composing process that is performed by the image processing apparatus according to the present invention will be described with reference to a flowchart illustrated in FIG. 11.

The process according to the flowchart illustrated in FIG. 11, for example, is performed under the control of the control unit disposed inside the imaging apparatus 200 that is illustrated in FIG. 10.

The process of each step of the flowchart that is illustrated in FIG. 11 will be described.

First, after a hardware diagnosis and the initialization are performed in accordance with turning the power on, the image processing apparatus (for example, the imaging apparatus 200) proceeds to Step S101.

In Step S101, various capturing parameters are calculated. In this Step S101, for example, information relating to the brightness identified by an exposure system is acquired, and capturing parameters such as a diaphragm value and a shutter speed are calculated.

Next, the process proceeds to Step S102, and the control unit determines whether or not a shutter operation is performed by a user. Here, it is assumed that the 3D image panorama photographing mode has been set in advance.

In the 3D image panorama photographing mode, a process is performed in which a plurality of images are consecutively captured in accordance with user's shutter operations, left-eye image strips and right-eye image strips are cut out from the captured images, and a left-eye composition image (panoramic image) and a right-eye composition image (panoramic image) that can be used for displaying a 3D image are generated and recorded.

In Step S102, in a case where a user's shutter operation has not been detected by the control unit, the process is returned to Step S101.

On the other hand, in Step S102, in a case where a user's shutter operation is detected by the control unit, the process proceeds to Step S103.

In Step S103, the control unit starts a capturing process by performing control that is based on the parameters calculated in Step S101. More specifically, for example, the adjustment of a diaphragm driving unit of the lens system 201 illustrated in FIG. 10 and the like are performed, and image capturing is started.

The image capturing process is performed as a process in which a plurality of images are consecutively captured. Electrical signals corresponding to the consecutively captured images are sequentially read out from the imaging device 202 illustrated in FIG. 10, the process of gamma correction, a contour enhancing correction, or the like is performed by the image signal processing unit 203, and the results of the process are displayed on the display unit 204 and are sequentially supplied to the memories 205 and 206 and the movement amount detecting unit 207.

Next, the process proceeds to Step S104, and the amount of movement between images is calculated. This process is the process of the movement amount detecting unit 207 illustrated in FIG. 10.

The movement amount detecting unit 207 acquires an image of a frame that is one frame before, which is stored in the image memory (for detecting the amount of movement) 206, together with the image signal that is supplied from the image signal processing unit 203 and detects the amount of movement between the current image and the image of the frame that is one frame before.

In addition, as the amount of movement that is calculated here, as described above, the number of pixels moved between the images is calculated, for example, by performing a process of matching pixels configuring two images that are consecutively captured, in other words, a matching process in which captured areas of the same subject are determined. In addition, basically, the process is performed while assuming that the subject is stopped. In a case where there is a moving subject, although a motion vector other than a motion vector of the whole image is detected, the process is performed while the motion vector corresponding to the moving subject is not set as a detection target. In other words, a motion vector (GMV: global motion vector) corresponding to the movement of the whole image that occurs in accordance with the movement of the camera is detected.

In addition, for example, the amount of movement is calculated as the number of moved pixels. The amount of movement of image n is calculated by comparing image n and image n−1 that precedes image n, and the detected amount of movement (number of pixels) is stored in the movement amount memory 208 as an amount of movement corresponding to image n.

This movement use storing process corresponds to the storage process of Step S105. In Step S105, the amount of movement between images that is detected in Step S104 is stored in the movement amount memory 208 illustrated in FIG. 10 in association with the ID of each one of the consecutively captured images.

Next, the process proceeds to Step S106, and, the image that is captured in Step S103 and is processed by the image signal processing unit 203 is stored in the image memory (for the composing process) 205 illustrated in FIG. 10. In addition, as described above, although this image memory (for the composing process) 205 may be configured such that all the images, for example, n+1 images that are captured in the panorama photographing mode (or the 3D image panorama photographing mode) are stored therein, for example, the image memory 205 may be set such that end portions of an image is clipped out, and only a center area of the image from which strip areas that are necessary for generating a panoramic image (3D panoramic image) is selected so as to be stored. Through such setting, a required memory capacity can be reduced. Furthermore, in the image memory (for the composing process) 205, an image may be configured to be stored after a compression process such as JPEG or the like is performed for the image.

Next, the process proceeds to Step S107, and the control unit determines whether or not the shutter is continued to be pressed by the user. In other words, the timing of completion of capturing is determined.

In a case where the shutter is continued to be pressed by the user, the process is returned to Step S103 so as to continue the capturing process, and the imaging of the subject is repeated.

On the other hand, in Step S107, in a case where the pressing of the shutter is determined to have ended, in order to proceeds to a capturing ending operation, the process proceeds to Step S108.

When the consecutive image capturing ends in the panorama photographing mode, in Step S108, the image composing unit 220 determines a process to be performed. In other words, the image composing unit 220 receives the detection information (information that is acquired through sensor detection or image analysis) of the turning momentum detecting unit 211 and the translational momentum detecting unit 212 as inputs and determines the aspect of the process.

More specifically, the image composing unit 220 performs one of the following processes including:
(a1) generation of a 3D panoramic image;
(a2) generation of a 3D panoramic image (accompanying a reversal process of LR images) ;
(b) generation of a 2D panoramic image; and
(c) no generation of both 3D and 2D panoramic images.

In addition, as illustrated in (a1) and (a2), also in a case where a 3D panoramic image is generated, there is a case where the reversal of LR images (the left-eye image and the right-eye image) in accordance with the detection information.

Furthermore, in a case where both the 3D and 2D panoramic images are not generated, a case where the process proceeds to the determined process, or the like, a notification or a warning is output to the user in each scene.

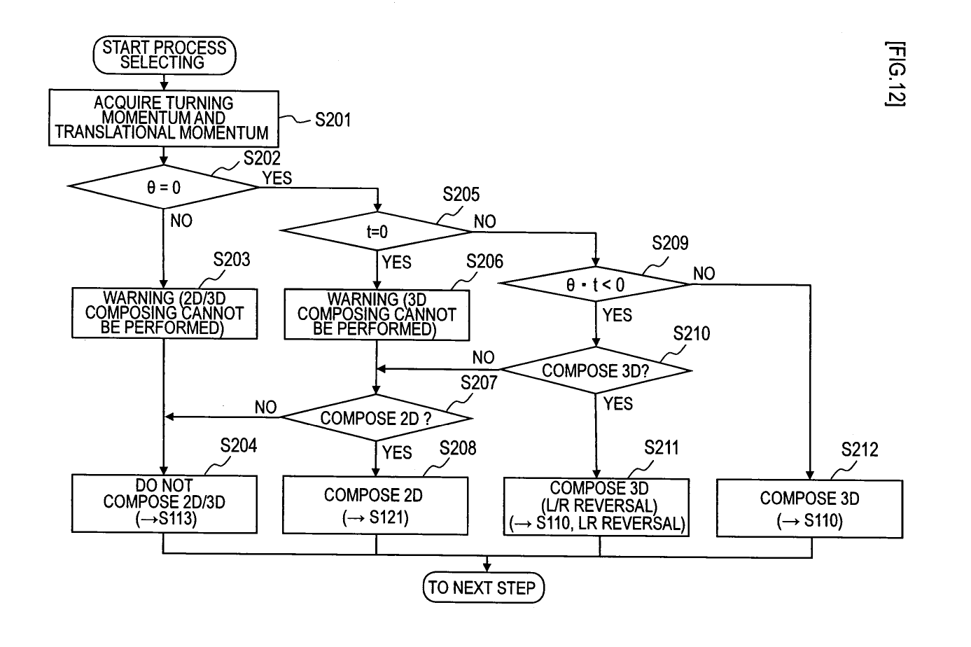

A specific example of the process of determining the process to be performed, which is illustrated in Step S108, will be described with reference to a flowchart illustrated in FIG. 12.

In Step S201, the image composing unit 220 receives the detection information of the turning momentum detecting unit 211 and the translational momentum detecting unit 212 (the information acquired through sensor detection or image analysis) as inputs.

In addition, the turning momentum detecting unit 211 acquires or calculates the turning momentum θ of the camera at time point when an image as an image composing process target of the image composing unit 220 is captured and outputs the value to the image composing unit 220. Here, the detection information of the turning momentum detecting unit 211 may be set so as to be directly output from the turning momentum detecting unit 211 to the image composing unit 220, or it may be configured such that the detection information is recorded in the memory as the attribute information of the image together with the image, and the image composing unit 220 acquires the value that is recorded in the memory.

Furthermore, the translational momentum detecting unit 212 acquires or calculates the translational momentum t of the camera at time point when an image as an image composing process target of the image composing unit 220 is captured and outputs the value to the image composing unit 220. Here, the detection information of the translational momentum detecting unit 212 may be set so as to be directly output from the translational momentum detecting unit 212 to the image composing unit 220, or it may be configured such that the detection information is recorded in the memory as the attribute information of the image together with the image, and the image composing unit 220 acquires the value that is recorded in the memory.

In addition, the turning momentum detecting unit 211 and the translational momentum detecting unit 212, for example, are configured by a sensor or an image analyzing unit. A specific configuration example and a processing example will be described in a later stage.

The image composing unit 220, first, in Step S202, determines whether or not the turning momentum θ of the camera at the time of capturing an image, which is acquired by the turning momentum detecting unit 211, is equal to zero. In addition, a process may be configured to be performed in which zero is determined in consideration of a measurement error or the like in a case where a detected value is not completely equal to zero but has a difference from zero in an allowed range set in advance.

In a case where the turning momentum of the camera at the time of capturing an image is determined to be zero θ=0 in Step S202, the process proceeds to Step S203, and, in a case where it is determined that θ≠0, the process proceeds to Step S205.

In a case where the turning momentum of the camera at the time of capturing an image is determined to be zero θ=0 in Step S202, the process proceeds to Step S203, and a warning for notifying a user that both the 2D panoramic image and the 3D panoramic image cannot be generated is output.

In addition, the determination information of the image composing unit 220 is output to the control unit of the apparatus, and a warning or a notification according to the determination information is displayed, for example, on the display unit 204 under the control of the control unit. Alternatively, a configuration may be employed in which an alarm is output.

A case where the turning momentum of the camera is zero θ=0 corresponds to an example described in advance with reference to FIG. 9(b1). In a case where image capturing accompanying such a movement, both the 2D panoramic image and the 3D panoramic image cannot be generated, and a warning for notifying a user of this is output.

After this warning is output, the process proceeds to Step S204, and the process ends without performing the image composing process.

On the other hand, in a case where the turning momentum of the camera at the time of capturing an image is determined not to be zero θ≠0 in Step S202, the process proceeds to Step S205, and it is determined whether or not the translational momentum t of the camera at the time of capturing an image, which is acquired by the translational momentum detecting unit 212, is equal to zero. In addition, a process may be configured to be performed in which zero is determined in consideration of a measurement error or the like in a case where a detected value is not completely equal to zero but has a difference from zero in an allowed range set in advance.

In a case where the translational momentum of the camera at the time of capturing an image is determined to be zero t=0 in Step S205, the process proceeds to Step S206, and, in a case where it is determined that t≠0, the process proceeds to Step S209.

In a case where the turning momentum of the camera at the time of capturing an image is determined to be zero t=0 in Step S205, the process proceeds to Step S206, and a warning for notifying a user that the generation of the 3D panoramic image cannot be performed is output.

A case where the turning momentum of the camera is zero t=0 is a case where there is no translational momentum of the camera. However, in this case, the turning momentum is determined not to be zero θ≠0 in Step S202 and is in a state in which some rotation is made. In this case, although a 3D panoramic image can be generated, a 2D panoramic image can be generated.

A warning for notifying a user of this situation is output.

After the warning is output in Step S206, the process proceeds to Step S207, and it is determined whether or not a 2D panoramic image is generated. This determination process, for example, is performed by inquiring of the user about the generation and performing a confirming process based on a user's input. Alternatively, the process is determined based on information that is set in advance.

In Step S207, in a case where a 2D panoramic image is determined to be generated, in Step S208, a 2D panoramic image is generated.

On the other hand, in a case where a 2D panoramic image is determined not to be generated in Step S207, the process proceeds to Step S204, and the process ends without performing the image composing process.

In Step S205, in a case where the translational momentum of the camera is determined not to be zero t≠0, the process proceeds to Step S209, and it is determined whether or not a value θ×t acquired by multiplying the turning momentum θ of the camera at the time of capturing an image and the translational momentum t is less than zero. The turning momentum θ of the camera, as illustrated in FIG. 5, is set to “+” for turning in the clockwise direction, and the translational momentum t of the camera, as illustrated in FIG. 5, is set to “+” for a movement toward the right side.

A case where a value acquired by multiplying the turning momentum θ and the translational momentum t of the camera at the time of capturing an image is equal to or greater than zero, in other words, a case where an equation of θ·t<0 is not satisfied is the following case (a1) or (a2).
(a1) θ>0 and t>0
(a2) θ<0 and t<0

The case of (a1) corresponds to an example illustrated in FIG. 5. In the case of (a2), the turning direction is opposite to that of the example illustrated in FIG. 5, and the direction of the translational movement is opposite to that of the above-described example.

In such a case, a left-eye panoramic image (L image) and a right-eye panoramic image (R image) for a normal 3D image can be generated.

In this case, in other words, in Step S209, a value θ×t acquired by multiplying the turning momentum θ and the translational momentum t of the camera at the time of capturing an image is equal to or greater than zero, in other words, in a case where an equation of θ·t<0 is determined not to be satisfied, the process proceeds to Step S212, and the process of generating a left-eye panoramic image (L image) and a right-eye panoramic image (R image) for a normal 3D image is performed.

On the other hand, in Step S209, a case where the value θ×t acquired by multiplying the turning momentum θ and the translational momentum t of the camera at the time of capturing an image is smaller than zero, in other words, a case where the equation of θ·t<0 is satisfied is the following case (b1) or (b2).
(b1) θ>0 and t<0
(b2) θ<0 and t>0

In this case, a process of exchanging the left-eye panoramic image (L image) and the right-eye panoramic image (R image) for a normal 3D image with each other is performed. In other words, by exchanging the LR images with each other, a left-eye panoramic image (L image) and a right-eye panoramic image (R image) for a normal 3D image can be generated.

In this case, the process proceeds to Step S210. In Step S210, it is determined whether or not a 3D panoramic image is generated. This determination process, for example, is performed by inquiring of the user about the generation and performing a confirming process based on a user's input. Alternatively, the process is determined based on information that is set in advance.

In Step S210, in a case where a 3D panoramic image is determined to be generated, in Step S211, a 3D panoramic image is generated. However, in the process of this case, differently from the process of generating a 3D panoramic image in Step S212, an LR image reversing process is performed in which the left-eye image (L image) generated through the same sequence as that of the process of generating a 3D panoramic image in S212 is set as a right-eye image (R image), and the right-eye image (R image) is set as a left-eye image (L image).

In a case where a 3D panoramic image is determined not to be generated in Step S210, the process proceeds to Step S207, and it is determined whether or not a 2D panoramic image is generated. This determination process, for example, is performed by inquiring of the user about the generation and performing a confirming process based on a user's input. Alternatively, the process is determined based on information that is set in advance.

In Step S207, in a case where a 2D panoramic image is determined to be generated, in Step S208, a 2D panoramic image is generated.

On the other hand, in a case where a 2D panoramic image is determined not to be generated in Step S207, the process proceeds to Step S204, and the process ends without performing the image composing process.

As above, the image composing unit 220 receives the detection information (the information acquired through sensor detection or image analysis) detected by the turning momentum detecting unit 211 and the translational momentum detecting unit 212 as inputs and determines the processing aspect.

This process is performed as the process of Step S108 illustrated in FIG. 11.

After the process of Step S108 is completed, the process proceeds to Step S109 illustrated in FIG. 11. Step S109 represents a branching step according to the determination of the process to be performed, which is made in Step S108. As illustrated with reference to the flow of FIG. 12, in accordance with the detection information (information that is acquired through sensor detection or image analysis) of the turning momentum detecting unit 211 and the translational momentum detecting unit 212, the image composing unit 220 determines one process of the following processes including:
(a1) generation of a 3D panoramic image (Step S212 of the flow illustrated in FIG. 12);
(a2) generation of a 3D panoramic image (accompanying the process of reversing the LR images) (Step S211 of the flow illustrated in FIG. 12);
(b) generation of a 2D panoramic image (Step S208 of the flow illustrated in FIG. 12); and
(c) no generation of both 3D and 2D panoramic images (Step S204 of the flow illustrated in FIG. 12).

In the process of Step S108, in a case where the process of (a1) or (a2) is determined, in other words, in a case where the 3D image composing process of Step S211 or S212 is determined as a process to be performed in the flow illustrated in FIG. 12, the process proceeds to Step S110.

In the process of Step S108, in a case where the process of (b) is determined, in other words, in a case where the 2D image composing process of Step S208 is determined as a process to be performed in the flow illustrated in FIG. 12, the process proceeds to Step S121.

In the process of Step S108, in a case where the process of (c) is determined, in other words, in a case where no image composing process of Step S204 is determined as a process to be performed in the flow illustrated in FIG. 12, the process proceeds to Step S113.

In the process of Step S108, in a case where the process of (c) is determined, in other words, in a case where no image composing process of Step S204 is determined as a process to be performed in the flow illustrated in FIG. 12, the process proceeds to Step S113, the captured image is recorded in the recording unit (recording medium) 221 without performing image composing, and the process ends. In addition, it may be configured such that, before this recording process, user confirmation is performed on whether or not an image is recorded, and the recording process is performed only in a case where the user has an intention of recording the image.

In the process of Step S108, in a case where the process of (b), in other words, the 2D image composing process of Step S208 is determined as a process to be performed in the flow illustrated in FIG. 12, the process proceeds to Step S121, an image composing process is performed as a 2D panoramic image generating process in which strips used for generating a 2D panoramic image are cut out from each image and are connected, the generated 2D panoramic image is recorded in the recording unit (recording medium) 221, and the process ends.

In the process of Step S108, in a case where the process of (a1) or (a2), in other words, the 3D image composing process of Step S211 or S212 is determined as a process to be performed in the flow illustrated in FIG. 12, the process proceeds to Step S110, and an image composing process is performed as a 3D panoramic image generating process in which strips used for generating a 3D panoramic image are cut out from each image and are connected.

First, in Step S110, the image composing unit 220 calculates the amount of offset between the stripped areas of the left-eye image and the right-eye image to be a 3D image, in other words, a distance (inter-strip offset) D between the stripped areas of the left-eye image and the right-eye image.

In addition, as described with reference to FIG. 6, in this specification, a distance between the 2D panoramic image strip 115 used for a two-dimensional composition image and the left-eye image strip 111 and a distance between the 2D panoramic image strip 115 and the right-eye image strip 112 are defined as “offsets” or “strip offsets”=d1 and d2, and a distance between the left-eye image strip 111 and the right-eye image strip 112 is defined as “inter-strip offset”=D.

In addition, the inter-strip offset=(strip offset)×2, and D=d1+d2.

In the process of calculating the distance D between the stripped areas of the left-eye image and the right-eye image and the strip offsets d1 and d2 in Step S110, for example, the offsets are set so as to satisfy the following conditions.
(Condition 1) Strip overlapping between the left-eye image strip and the right-eye image strip does not occur.
(Condition 2) The strips do not protrude outside an image area that is stored in the image memory (for the composing process) 205.

The strip offsets d1 and d2 that are set so as to satisfy Conditions 1 and 2 are calculated.

In Step S110, when the calculation of the inter-strip offset D, which is a distance between the stripped areas of the left-eye image and the right-eye image, is completed, the process proceeds to Step S111.

In Step S111, a first image composing process using captured images is performed. In addition, the process proceeds to Step S112, and a second image composing process using captured images is performed.

The image composing processes of Step S111 and S112 are the processes of generating a left-eye composition image and a right-eye composition image that are used for displaying a 3D image display. For example, the composition image is generated as a panoramic image.

As described above, the left-eye composition image is generated by the composing process in which only left-eye image strips are extracted and connected. The right-eye composition image is generated by the composing process in which only right-eye image strips are extracted and connected. As results of such composing processes, for example, two panoramic images illustrated in FIGS. 7(2a) and (2b) are generated.

The image composing processes of Steps S111 and S112 are performed by using a plurality of images (or partial images) stored in the image memory (for the composing process) 205 during capturing consecutive images after the determination on pressing the shutter is “Yes” in Step S102 until the end of the pressing of the shutter is checked in Step S107.

When this composition process is performed, the image composing unit 220 acquires the amounts of movement that are associated with a plurality of images from the movement amount memory 208 and receives the value of the inter-strip offset D=d1+d2 that is calculated in Step S110 as an input.

For example, in Step S111, the strip position of the left-eye image is determined by using the offset d1, and, in Step S112, the strip position of the left-eye image is determined by using the offset d1

In addition, although it may be configured such that d1=d2, it is not necessary to configure d1=d2.

The values of d1 and d2 maybe different from each other while the condition of D=d1+d2 is satisfied.

The image composing unit 220 sets the left-eye strips used for configuring the left-eye composition image to positions that are offset from the image center to the right side by a predetermined amount.

The right-eye strips used for configuring the right-eye composition image are set to positions that are offset from the image center to the left side by a predetermined amount.

When the stripped area setting process is performed, the image composing unit 220 determines strip areas so as to satisfy the offset condition that satisfies the condition for generating the left-eye image and the right-eye image that are formed as a 3D image.

The image composing unit 220 performs image composing by cutting out and connecting left-eye image strips and right-eye image strips of each image, thereby generating a left-eye composition image and a right-eye composition image.

In addition, in a case where the image (or the partial image) stored in the image memory (for the composing process) 205 is compressed data according to JPEG or the like, in order to achieve a high processing speed, an adaptive decompressing process may be configured to be performed in which an image area, in which compression such as JPEG or the like is decompressed, is set only in the stripped area used as a composition image based on the amount of movement between images that is acquired in Step S104.

Through the processes of Steps S111 and S112, a left-eye composition image and a right-eye composition image that are used for displaying a 3D image are generated.

In addition, in a case where the process of (al) generation of a 3D panoramic image (Step S212 of the flow illustrated in FIG. 12) is performed, the left-eye image (L image) and the right-eye image (R image) that are generated in the above-described process are directly stored on a medium as LR images for displaying a 3D image.

However, in a case where the process of (a2) generation of a 3D panoramic image (accompanying the process of reversal of the LR images) (Step S211 of the flow illustrated in FIG. 12) is performed, the left-eye image (L image) and the right-eye image (R image) that are generated in the above-described process are exchanged with each other, in other words, the LR images for displaying a 3D image are set such that the left-eye image (L image) generated in the above-described process is configured as a right-eye image (R image), and the right-eye image (R image) is configured as a left-eye image (L image).

Finally, the process proceeds to the next Step S113, the images composed in Steps S111 and S112 are generated in an appropriate recording format (for example, CIPA DC-007 Multi-Picture Format or the like) and are stored in the recording unit (recording medium) 221.

By performing the above-described steps, two images including the left-eye image and the right-eye image used for displaying a 3D image can be composed.

### 5. SPECIFIC CONFIGURATION EXAMPLE OF TURNING MOMENTUM DETECTING UNIT AND TRANSLATIONAL MOMENTUM DETECTING UNIT

Next, specific configuration examples of the turning momentum detecting unit 211 and the translational momentum detecting unit 212 will be described.

The turning momentum detecting unit 211 detects the turning momentum of the camera, and the translational momentum detecting unit 212 detects the translational momentum of the camera.

As specific examples of the detection configuration of each detection unit, the following three examples will be described.
(Example 1) Example of Detection Process Using Sensor
(Example 2) Example of Detection Process Through Image Analysis
(Example 3) Example of Detection Process Through Both Sensor and Image Analysis

Hereinafter, such process examples will be sequentially described.

### EXAMPLE 1

### Example of Detection Process Using Sensor

First, an example will be described in which the turning momentum detecting unit 211 and the translational momentum detecting unit 212 are configured by sensors.

The translational movement, for example, can be detected by using an acceleration sensor. Alternatively, the translational movement can be calculated from the latitude and the longitude by a GPS (Global Positioning System) using electric waves transmitted from satellites. In addition, a process for detecting the translational momentum using an acceleration sensor, for example, is disclosed in Japanese Unexamined Patent Application Publication No. 2000-78614.

In addition, regarding the turning movement (posture) of the camera, there are a method of measuring the bearing by referring to the direction of the terrestrial magnetism, a method of detecting an angle of inclination by using an accelerometer by referring to the direction of the gravitational force, a method using an angular sensor acquired by combining a vibration gyroscope and an acceleration sensor, and a calculation method for a calculation performed through comparison with a reference angle of the initial state using an acceleration sensor.

As above, the turning momentum detecting unit 211 can be configured by a terrestrial magnetic sensor, an accelerometer, a vibration gyroscope, an acceleration sensor, an angle sensor, an angular velocity sensor, or a combination of such sensors.

In addition, the translational momentum detecting unit 212 can be configured by an acceleration sensor or a GPS (Global Positioning System).

The turning momentum and the translational momentum of such sensors are provided directly or through the image memory (for the composing process) 205, to the image composing unit 210, and the image composing unit 210 determines the aspect of the composition process based on the detection values thereof.

### EXAMPLE 2

### Example of Detection Process Through Image Analysis

Next, an example will be described in which the turning momentum detecting unit 211 and the translational momentum detecting unit 212 are configured not as a sensor but as an image analyzing unit that receives captured images as inputs and performs image analysis.

In this example, the turning momentum detecting unit 211 and the translational momentum detecting unit 212 illustrated in FIG. 10 receive image data, which is a composition processing target, as an input from the image memory (for detecting the amount of movement) 205, perform analysis of the input images, and acquire a turning component and a translational component of the camera at the time point when the image is captured.

More specifically, first, characteristic amounts are extracted from the images, which have been consecutively captured, as composition targets by using a Harris corner detector or the like. In addition, an optical flow between the images is calculated by matching the characteristic amounts of the images or by dividing each image at even intervals and matching (block matching) in units of divided areas. Furthermore, on the premise that the camera model is a perspective projection image, a turning component and a translational component can be extracted by solving a non-linear equation using an iterative method. In addition, for example, this technique is described in detail in the following literature, and this technique can be used. “Multi View Geometry in Computer Vision”, Richard Hartley and Andrew Zisserman, Cambridge University Press

Alternatively, more simply, by assuming a subject to be planar, a method may be used in which homography is calculated from the optical flow, and a turning component and a translational component are calculated.

In a case where this example of the process is performed, the turning momentum detecting unit 211 and the translational momentum detecting unit 212 illustrated in FIG. 10 are configured as not a sensor but an image analyzing unit. The turning momentum detecting unit 211 and the translational momentum detecting unit 212 receives image data that is an image composing process target as an input from the image memory (for detecting the amount of movement) 205 and performs image analysis of the input image, thereby acquiring a turning component and a translational component of the camera at the time of capturing an image.

### EXAMPLE 3

### Example of Detection Process Through Both Sensor and Image Analysis

Next, an example of the process will be described in which the turning momentum detecting unit 211 and the translational momentum detecting unit 212 include both functions of a sensor and an image analyzing unit and acquires both sensor detection information and the image analyzing information.

An example will be described in which the units are configured as the image analyzing unit that receives captured images as inputs and performs image analysis.

The consecutively captured images are formed as consecutively captured images including only a translational movement through a correction process such that the angular velocity is zero based on the angular velocity data acquired by the angular velocity sensor, and the translational movement can be calculated based on the acceleration data that is acquired by the acceleration sensor and the consecutively captured images after the correction process. For example, this process is disclosed in Japanese Unexamined Patent Application Publication No. 2000-222580.

In this example of the process, of the turning momentum detecting unit 211 and the translational momentum detecting unit 212, the translational momentum detecting unit 212 is configured so as to have an angular velocity sensor and an image analyzing unit, and by employing such a configuration, the translational momentum at the time of capturing images is calculated by using the technique disclosed in Japanese Unexamined Patent Application Publication No. 2000-222580.

The turning momentum detecting unit 211 is assumed to have the configuration of the sensor or the configuration of the image analyzing unit described in one of (Example 1) Example of Detection Process Using Sensor and (Example 2) Example of Detection Process Through Image Analysis.

### 6. EXAMPLE OF SWITCHING BETWEEN PROCESSES BASED ON TURNING MOMENTUM AND TRANSLATIONAL MOMENTUM

Next, an example of switching that is based on the turning momentum and the translational momentum of the camera will be described.

As formerly described with reference to the flowchart illustrated in FIG. 12, the image composing unit 220 changes the processing aspect based on the turning momentum and the translational momentum of the imaging apparatus (camera) at the time of capturing images that are acquired or calculated by the process of the turning momentum detecting unit 211 and the translational momentum detecting unit 212 described above.

More specifically, the image composing unit 220, in accordance with the detection information (information acquired through sensor detection or image analysis) of the turning momentum detecting unit 211 and the translational momentum detecting unit 212, determines one of the following processes including:
(a1) generation of a 3D panoramic image (Step S212 of the flow illustrated in FIG. 12);
(a2) generation of a 3D panoramic image (accompanying the process of reversing the LR images) (Step S211 of the flow illustrated in FIG. 12);
(b) generation of a 2D panoramic image (Step S208 of the flow illustrated in FIG. 12); and
(c) no generation of both 3D and 2D panoramic images (Step S204 of the flow illustrated in FIG. 12).

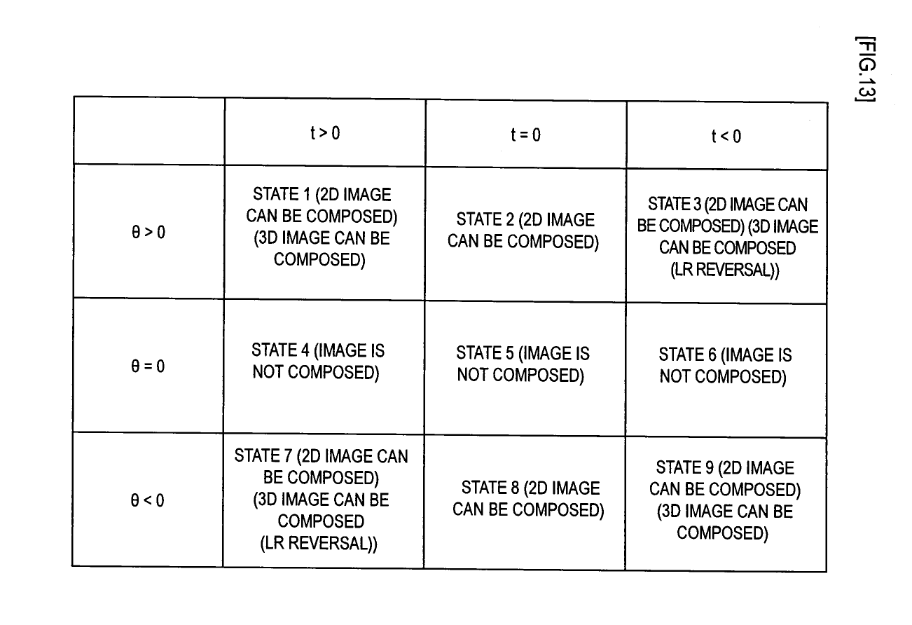

A diagram that summarizes the detection information of the turning momentum detecting unit 211 and the translational momentum detecting unit 212 and the process that is determined in accordance with the detection information is illustrated in FIG. 13.

In a case where the turning momentum θ of the camera is zero (State 4, State 5, or State 6), since neither a 2D image nor a 3D image can be correctly performed, feedback such as giving a warning is performed for a user, and the process is returned again to a capturing waiting state without performing an image composing process.

In a case where the turning momentum θ of the camera is not zero, and in a case where the translational momentum t is zero (State 2 or State 8), even when 3D capturing is performed, disparity cannot be acquired, and accordingly, only 2D composing is performed, or feedback such as giving a warning is performed for a user, and the process is returned to the waiting state.

In a case where the turning momentum θ of the camera is not zero and the translational momentum t is not zero (in a case where both are not zero), and when the signs of the turning momentum θ and the translational momentum t are opposite to each other, in other words, θ·t<0 (State 3 or State 7), either 2D composing or 3D composing can be performed. However, since capturing is performed in the direction in which the optical axes of the camera intersect with each other, in the case of composing a 3D image, it is necessary to record images with the polarities of a left image and a right image being inverted.

In this case, for example, which image is to be recorded is checked by asking it to a user, and then, a process desired by the user is performed. In a case where the user does not desire data recording, the image is not recorded, and the process is returned to the waiting state.

In addition, in a case where the turning momentum θ is not zero and the translational momentum t is not zero (in a case where both are not zero), and when the signs of the turning momentum θ and the translational momentum t are the same in other word, θ·t>0 (State 1 or State 9), either 2D composing or 3D composing can be performed.

In this case, since the camera is assumed to be in the moving state, 3D composing is performed, and the process is returned to the waiting state. In addition, also in this case, after an image to be recorded out of a 2D image and a 3D image is checked by being asked to the user, a process desired by the user may be set to be performed. In a case where the user does not desire data recording, the image is not recorded, and the process is returned to the waiting state.

As above, according to the configuration of the present invention, in a configuration in which a left-eye image and a right-eye image as a 3D image or a 2D panoramic image is generated by composing images captured by a user under various conditions, a composition image that can be generated is determined based on the turning momentum θ and the translational momentum t of the camera, an image composing process that can be generated is performed for an image that can be generated, and a checking process for the user is performed so as to perform an image composing process that is desired by the user.

Accordingly, it is possible to reliably generate an image that is desired by the user and record the image on a medium.

As above, the present invention has been described in detail by referring to the specific embodiment. However, it is apparent that those skilled in the art can modify or replace the embodiment within a range not departing from the concept of the present invention. In other words, since the present invention is disclosed in the form of an example, it must not be interpreted in a limited way. In other to determine the concept of the present invention, the claims must be referred to.

A series of processes described in this specification can be performed by hardware, software, or a combined configuration of both hardware and software. In a case where the processes are performed by software, it maybe configured such that a program in which the processing sequence is recorded is installed to a memory disposed inside a computer that is built in dedicated hardware and is executed, or a program is installed to a general-purpose computer that can perform various processes and is executed. For example, the program may be recorded on a recording medium in advance. Instead of installing the program from a recording medium, it may be configured such that the program is received through a network such as a LAN (Local Area Network) or the Internet and is installed to a recording medium such as a hard disk that is built therein.

In addition, various processes described in this specification may be performed in a time series following the description, or may be performed in parallel with or independently from each other, depending on the processing capability of an apparatus that performs the processes or as necessary. A system described in this specification represents logically integrated configurations of a plurality of apparatuses, and the apparatuses of the configurations are not limited to being disposed inside a same casing.

### INDUSTRIAL APPLICABILITY

As described above, according to the configuration of an embodiment of the present invention, in the configuration in which a two-dimensional panoramic image or images used for displaying a three-dimensional image are generated by connecting stripped areas cut out from a plurality of images, a configuration is realized in which a composition image that can be generated is determined based on the movement of the camera, and the determined composition image is generated. In the configuration in which a two-dimensional panoramic image or a left-eye composition image or a right-eye composition image for displaying a three-dimensional image are generated by connecting stripped areas cut out from a plurality of images, it is determined whether or not a two-dimensional panoramic image or a three-dimensional image can be generated by analyzing the information of the movement of the imaging apparatus at the time of capturing images, and the process of generating a composition image that can be generated is performed. In accordance with the turning momentum (θ) and the translational momentum (t) of the camera at the time of capturing images, one processing aspect is determined from among (a) a composition image generating process of a left-eye composition image and a right-eye composition image that are used for displaying a three-dimensional image, (b) a composition image generating process of a two-dimensional panoramic image, and (c) stopping composition image generating, and the determined process is performed. In addition, notifying the content of the processing or giving a warning is performed for the user.

### REFERENCE SIGNS LIST

10 camera

20 image

21 2D panoramic image strip

30 2D panoramic image

51 left-eye image strip

52 right-eye image strip

70 imaging device

72 left-eye image

73 right-eye image

100 camera

101 virtual imaging surface

102 optical center

110 image

111 left-eye image strip

112 right-eye image strip

115 2D panoramic image strip

200 imaging apparatus

201 lens system

202 imaging device

203 image signal processing unit

204 display unit

205 image memory (for composing process)

206 image memory (for detecting amount of movement)

207 movement amount detecting unit

208 movement amount memory

211 turning momentum detecting unit

212 translational momentum detecting unit

220 image composing unit

221 recording unit

1. An image processing apparatus comprising:
an image composing unit that generates a composition image by connecting stripped areas that are cut out from each image of a plurality of images captured from mutually different positions,
wherein the image composing unit determines one processing aspect based on movement information of an imaging apparatus at the time of capturing an image from among (a) a composition image generating process of a left-eye composition image and a right-eye composition image that are used for displaying a three-dimensional image, (b) a composition image generating process of a two-dimensional panoramic image, and (c) stopping composition image generating and performs the determined process.

2. The image processing apparatus according to claim 1, further comprising:
a turning momentum detecting unit that acquires or calculates turning momentum (θ) of the imaging apparatus at the time of capturing an image; and
a translational momentum detecting unit that acquires or calculates translational momentum (t) of the imaging apparatus at the time of capturing an image; and
wherein the image composing unit determines the processing aspect based on the turning momentum (θ) detected by the turning momentum detecting unit and the translational momentum (t) detected by the translational momentum detecting unit.

3. The image processing apparatus according to claim 1, further comprising an output unit that presents a warning or a notification to a user in accordance with information of the determination of the image composing unit.

4. The image processing apparatus according to claim 2, wherein the image composing unit stops the composition image generating process of the three-dimensional image and the two-dimensional panoramic image in a case where the turning momentum (θ) detected by the turning momentum detecting unit is zero.

5. The image processing apparatus according to claim 2, wherein the image composing unit performs one of the composition image generating process of a two-dimensional panoramic image and the stopping composition image generating in a case where the turning momentum (θ) detected by the turning momentum detecting unit is not zero, and the translational momentum (t) detected by the translational momentum detecting unit is zero.

6. The image processing apparatus according to claim 2, wherein the image composing unit performs one of the composition image generating process of a three-dimensional image and the composition image generating process of a two-dimensional panoramic image in a case where the turning momentum (θ) detected by the turning momentum detecting unit is not zero, and the translational momentum (t) detected by the translational momentum detecting unit is not zero.

7. The image processing apparatus according to claim 6, wherein, in a case where case where the turning momentum (θ) detected by the turning momentum detecting unit is not zero, and the translational momentum (t) detected by the translational momentum detecting unit is not zero, the image composing unit performs a process in which LR images of the 3D image, which are to be generated, are reversely set in a case where θ·t<0 and in a case where θ·t>0.

8. The image processing apparatus according to claim 2, wherein the turning momentum detecting unit is a sensor that detects the turning momentum of the image processing apparatus.

9. The image processing apparatus according to claim 2, wherein the translational momentum detecting unit is a sensor that detects the translational momentum of the image processing apparatus.

10. The image processing apparatus according to claim 2, wherein the turning momentum detecting unit is an image analyzing unit that detects the turning momentum at the time of capturing an image by analyzing captured images.

11. The image processing apparatus according to claim 2, wherein the translational momentum detecting unit is an image analyzing unit that detects the translational momentum at the time of capturing an image by analyzing captured images.

12. An imaging apparatus comprising:
an imaging unit; and
an image processing unit that performs the image processing according to claim 1.

13. An image processing method that is performed in an image processing apparatus, the image processing method comprising:
generating a composition image by connecting stripped areas that are cut out from each image of a plurality of images captured from mutually different positions by using an image composing unit,
wherein, in the generating of a composition image, one processing aspect is determined based on movement information of an imaging apparatus at the time of capturing an image from among (a) a composition image generating process of a left-eye composition image and a right-eye composition image that are used for displaying a three-dimensional image, (b) a composition image generating process of a two-dimensional panoramic image, and (c) stopping composition image generating, and the determined process is performed.

14. A non-transitory computer readable medium including computer executable instructions that cause an image processing apparatus to perform image processing, the program causing an image composing unit to perform generating a composition image by connecting stripped areas that are cut out from each of a plurality of images captured from mutually different positions,
wherein, in the generating of a composition image, one processing aspect is determined based on movement information of an imaging apparatus at the time of capturing an image from among (a) a composition image generating process of a left-eye composition image and a right-eye composition image that are used for displaying a three-dimensional image, (b) a composition image generating process of a two-dimensional panoramic image, and (c) stopping composition image generating, and the determined process is performed.
